(19) United States
(12) Patent Application Publication
(10) Pub. No.: US 2025/0265458 A1
(43) Pub. Date: Aug. 21, 2025

(54) CONSTELLATION FEATURE MATCHING FOR MACHINE LEARNING

(71) Applicant: QUALCOMM Incorporated, San Diego, CA (US)

(72) Inventors: Jamie Menjay LIN, San Diego, CA (US); Kai WANG, San Diego, CA (US)

(21) Appl. No.: 18/583,533

(22) Filed: Feb. 21, 2024

(51) Int. Cl. G06N 3/08

(52) U.S. Cl. CPC G06N 3/08

(57) ABSTRACT

Certain aspects of the present disclosure provide techniques and apparatus for improved machine learning. In an example method, a reference tensor corresponding to a reference image and a target tensor corresponding to a target image are accessed. A constellation set is used to perform feature matching for the reference and target tensors while processing data using the artificial neural network, where the constellation set comprises a set of offsets. The feature matching includes, for each respective offset of the first constellation set, shifting the target tensor based on the respective offset, generating a respective intermediate tensor based on elementwise multiplying the reference tensor and the shifted target tensor, and generating a respective flattened tensor based on flattening the respective intermediate tensor. The respective flattened tensors are aggregated to generate a correlation tensor for the reference and target tensors.

### INTRODUCTION

Aspects of the present disclosure relate to machine learning.

A wide variety of machine learning models have been trained for a similarly vast assortment of tasks in recent years. Feature matching (also referred to in some aspects as feature search) is a technique commonly used in a variety of machine learning models, such as computer vision models. For example, feature matching may be used for keypoint and/or landmark detection, two and/or three dimensional object localization and/or tracking, two and/or three dimensional geometric correspondence (e.g., motion estimation, depth estimation, etc.), and the like.

In some conventional systems, the feature matching process is generally a computationally intensive operation (both during training, as well as during inferencing). In many cases, the feature matching serves as the bottleneck for performance (e.g., in terms of latency and/or power consumption). Further, in some conventional systems, feature matching has a substantial memory footprint. Some conventional approaches to provide feature matching are generally inefficient, slow, and/or unsupported by a wide variety of devices (e.g., edge devices).

### BRIEF SUMMARY

Certain aspects of the present disclosure provide a processor-implemented method, comprising: accessing a reference tensor corresponding to a reference image; accessing a target tensor corresponding to a target image; and using a first constellation set to perform feature matching for the reference and target tensors while processing data using the artificial neural network, wherein the first constellation set comprises a set of offsets, the feature matching comprising: for each respective offset of the first constellation set: shifting the target tensor based on the respective offset; generating a respective intermediate tensor based on elementwise multiplying the reference tensor and the shifted target tensor; and generating a respective flattened tensor based on flattening the respective intermediate tensor; and aggregating the respective flattened tensors to generate a correlation tensor for the reference and target tensors.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example workflow for constellation feature matching for machine learning, according to some aspects of the present disclosure.

FIGS. 2A, 2B, and 2C depict example constellation sets for machine learning feature matching, according to some aspects of the present disclosure.

FIG. 3 depicts an architecture for adaptive constellation feature matching for machine learning, according to some aspects of the present disclosure.

FIG. 4 is a flow diagram depicting an example method for constellation feature matching for machine learning models, according to some aspects of the present disclosure.

FIG. 5 is a flow diagram depicting an example method for feature matching, according to some aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning.

In some aspects, a tensor-composite sampling technique is provided to perform feature matching using constellation sets. As discussed below in more detail, the constellation feature matching eliminates the reliance on inefficient and/or slow convolution-based kernel striding (used in some conventional architectures for feature matching), and avoids use of the memory-inefficient (e.g., quadratic) transformer-based token searching used in some conventional architectures.

In some aspects, constellations (also referred to in some aspects as constellation sets and/or constellation functions) are used to facilitate adaptive constellation search. Given a feature map (e.g., a tensor) of shape B×D×H×W with two-dimensional feature coordinates in H and W (e.g., a feature map generated based on an image), a constellation can be defined. In some aspects, the constellation comprises an indexed list of size ∥C∥ that contains coordinates of a number of features relative to any arbitrary center point. For example, as discussed below in more detail, a constellation set may comprise indices {(−2,2), (2,−2), (0,0), (−2,2), (2,2)}. In some aspects, the constellation set is an unordered list of indices or offsets relative to some defined point (e.g., the center of the constellation). Though two-dimensional constellations are described in certain aspects of the present disclosure for conceptual clarity, such constellations may be extended to higher dimensional cases (e.g., three-dimensional constellations) without loss of generosity.

In some aspects, using a constellation set, feature sampling or matching can be performed by generating a stack of shifted feature maps according to the (relative) coordinates described by the constellation. In particular, in some aspects, an efficient correlation-based derivation of disparity costs can be provided by computing inner products of each shifted target feature maps against the (non-shifted) reference feature map. In some aspects, the output of the map-to-map inner product in the depth or channel dimension (e.g., of a tensor having an original shape of B×D×H×W) can result in a tensor of dimensionality B×1×H×W. By performing this operation for each index or coordinate specified in the constellation set, ∥C∥ tensors may be generated.

In some aspects, the system can then stack those ∥C∥ copies of shifted target feature maps along the original dimension of D (after concomitant padding) to align the boundaries, resulting in a correlation tensor of dimensionality B×∥C∥×H×W. This correlation tensor, which indicates the feature matching results for the target and reference feature maps, may then be used or processed for a variety of downstream operations, such as by processing the correlation tensor using one or more convolution operations to generate model output.

In some aspects of the present disclosure, feature sampling for search against a given constellation set is not performed using convolutions and striding. Instead, the constellation approach performs feature search and match through sparse sampling of composite tensors, which is direct and fast. This is especially true when the constellation indices are sparse and distant from the central point in the constellation. Further, the constellation function supports any arbitrary definition of element coordinates. In these ways, constellation search can be used to perform feature matching in a way that is both fast and with small memory use.

In some aspects, a constellation set may be derived or defined by design (e.g., manually specifying the indices) and/or through learning (e.g., using a Gumbel-Softmax assisted, or neural architecture search, approach) using one or more training dataset(s). For example, by applying a defined and conditioned Gumbel-Softmax sampling or neural architecture search, the system may be able to use a temperature conditioning function with a soft masking (along with a parameter indicating the number of indices to include) to derive a constellation set through model training against a target dataset.

In some aspects, use of a given constellation set to perform feature matching results in a latency cost that is nearly linear to the size of the constellation set (e.g., the number of indices included) and is not dependent on the pattern itself. In some aspects, the feature matching accuracy may be sensitive to the particular constellation set. That is, different constellation sets (with different indices or coordinates) may result in substantially different performance on a given dataset. In some aspects, an adaptive or dynamic constellation search is provided, where the constellation set used to perform feature matching for a given input is determined based at least in part on the given input.

For example, though a constellation set with a larger receptive field may be efficient (e.g., using fewer iterations to be applied) and may allow for accurate long-range feature matching across large distances in H×W, such larger constellations may suffer decreased accuracy for short-range features (e.g., losing granularity for feature matching near the center of the constellation). In some aspects, based on frame-to-frame coherence (e.g., based on how similar the reference tensor and the target tensor are), the system may therefore select an appropriate constellation set (e.g., using a rules-based or trained model to select the constellation set), as discussed in more detail below.

### Example Workflow for Constellation Feature Matching for Machine Learning

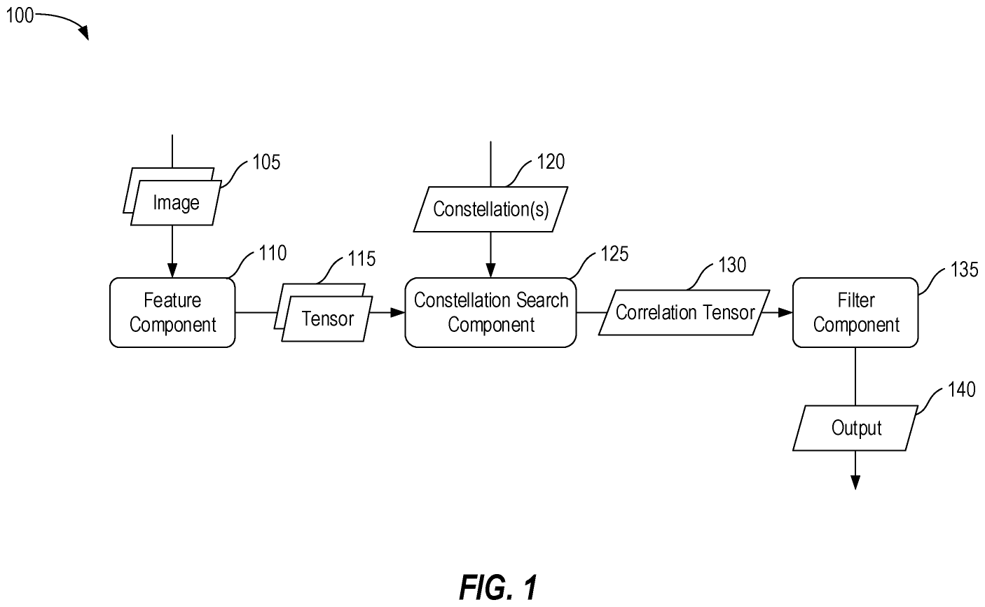

FIG. 1 depicts an example workflow 100 for constellation feature matching for machine learning, according to some aspects of the present disclosure.

In the illustrated example, a feature component 110, a constellation search component 125, and a filter component 135 are used to generate output 140 based on input image(s) 105. In some aspects, the feature component 110, the constellation search component 125, and the filter component may correspond to respective portions of a machine learning model, such as an artificial neural network. In some aspects, the machine learning model is used by a computing system (e.g., a machine learning system) to perform a variety of tasks that involve feature matching. For example, the machine learning system may be part of an autonomous driving system and/or driver assist system, and may process input images 105 to perform tasks such as keypoint and/or landmark detection, two and/or three dimensional object localization and/or tracking, two and/or three dimensional geometric correspondence (e.g., motion estimation, depth estimation, etc.), and the like. Generally, the illustrated components and operations may be implemented using hardware, software, or a combination of hardware and software.

In the illustrated workflow 100, a set of one or more images 105 are accessed by the feature component 110. As used herein, “accessing” data may generally include receiving, requesting, retrieving, generating, collecting, obtaining, or otherwise gaining access to the data. For example, the image(s) 105 may be captured using one or more imaging sensors (e.g., cameras), and provided to the feature component 110 for evaluation. In some aspects, the images 105 correspond to frames of a video.

The feature component 110 can generally be used to perform a variety of operations to prepare the images 105 for feature matching. For example, the feature component 110 may perform feature extraction to generate the tensors 115 (referred to in some aspects as feature maps). In some aspects, the feature component 110 generates a corresponding tensor 115 for each image 105. In some aspects, the feature component 110 generates a set of tensors 115 for each image 105 (e.g., where the spatial dimensions of each tensor 115 is smaller than the height and width of the image 105).

In some aspects, the feature matching operation is performed on sets of two or more images 105 (e.g., for a pair of images). For example, the feature matching operation may be performed for each pair of adjacent frames in a video. In some aspects, for a given feature match operation, one image 105 may be referred to as a reference image 105 (and the corresponding feature map(s) may be referred to as the reference tensor(s) 115) while the other image is referred to as the target image 105 (and the corresponding feature map(s) may be referred to as the target tensor(s) 115). For example, the image 105 with an earlier timestamp may be used as the reference image, while the subsequent frame (with a later timestamp) may be the target image. In some aspects, the target image for a given feature match operation may serve as the reference image for another feature match operation. For example, a first and second image may be processed, where the second image is the target image, and the second image may then be processed with a third image, where the second image is the reference image. Notwithstanding the above, the images 105 may not have any particular ordering, and may generally be referred to using any nomenclature. Use of “reference” and “target” in aspects of the present disclosure is merely for conceptual clarity.

As illustrated, the tensors 115 are then accessed by the constellation search component 125. The constellation search component 125 further accesses a set of constellation sets 120. As discussed above, each constellation set 120 generally comprises an unordered list of indices or offsets relative to a defined origin of the constellation set 120. For example, if the origin is the center of the constellation, the offsets may be defined using positive and/or negative values on the horizontal and vertical aces (for a two-dimensional constellation). Similarly, if the origin is at the corner of the constellation (e.g., the bottom left corner), the offsets may be defined using positive values in the horizontal and vertical axes.

As discussed above, in some aspects, some or all of the constellation sets 120 may be manually defined or specified (e.g., as hyperparameters for the model). For example, a user may select or indicate the offset(s) to be included in a given constellation set 120. This may allow users to fine-tune one or more constellation sets 120 specifically for a given dataset or desired operation (e.g., to balance short-range and long-range feature matching accuracy, latency, computational expense, and the like). In some aspects, some or all of the constellation sets 120 may be learned during a training phase (e.g., using training data to learn which offset(s) or indices should be included in a given constellation set 120, such as based on where matching features are generally located and how the matching features move in adjacent frames of data in the training dataset). For example, when training on a dataset with long-range feature interactions (e.g., where there is significant motion from frame to frame), the system may learn to generate constellation set(s) 120 with large receptive fields. When training on a dataset with short-range granular feature interactions, the system may learn to generate constellation set(s) 120 with smaller receptive fields and/or dense constellation centers.

In the illustrated example, the constellation search component 125 uses one or more constellation sets 120 to process the tensors 115 in order to generate a correlation tensor 130. In some aspects, the constellation search component 125 dynamically or adaptively selects the constellation set(s) 120 to use based at least in part on the tensors 115 themselves. For example, the constellation search component 125 may determine the disparity or coherence between the tensors 115 and/or images 105, and use a rules-based system (e.g., based on criteria such as threshold coherence) to select a constellation set 120.

Generally, the constellation search component 125 may use a variety of operations or techniques to determine the coherence between the data. For example, the constellation search component 125 may compute an element-wise difference between the tensors 115, and evaluate the aggregation of the absolute value of differences (e.g., the average or median absolute value of the differences) against one or more defined thresholds. If the aggregate difference is less than a threshold, the constellation search component 125 may determine that the tensors 115 are coherent. As another example, the constellation search component 125 may compute an element-wise difference between the tensors 115, and compare the maximum difference (or one or more predefined percentiles in the sorted set of differences) against a defined threshold. If the maximum (or defined percentile) of differences are less than the threshold, the constellation search component 125 may determine that the tensors 115 are coherent. As yet another example, the constellation search component 125 may compute an element-wise difference between the tensors 115, and compare the number or percentage of pixels that differ by a threshold (minimum) amount against one or more defined thresholds. If the number (or percentage) is less than the threshold, the constellation search component 125 may determine that the tensors 115 are coherent.

In some aspects, in addition to or instead of determining a binary coherence, the constellation search component 125 may determine a coherence score between the data, performing more granular constellation selection depending on the particular coherence score.

Generally, there are a variety of operations or selections may be performed based on the tensor (or image) coherence. For example, in some aspects, the constellation search component 125 may select a constellation set 120 with a smaller receptive field if the coherence is high (e.g., for general disparity), and may select a constellation set 120 with a relatively larger receptive field if the coherence is low (e.g., for large disparity conditions).

In some aspects, to select the constellation set(s) 120, the constellation search component 125 may process the reference tensor 115, the target tensor 115, and/or the determined coherence between the tensors 115 using a classifier machine learning model (e.g., a small neural network trained to select a constellation set 120 based on the input feature map(s) and/or disparity map(s)). For example, the constellation search component 125 (or another component or system) may train a constellation selection model using training records, each record comprising a pair of tensors 115 and/or a disparity map between the tensors, and a label indicating which constellation set(s) 120 should be used to perform feature mapping for the tensors.

In some aspects, the constellation search component 125 may additionally or alternatively select the constellation set(s) 120 based on the progress (e.g., the iteration index) of the feature matching. For example, if multiple iterations of feature matching are performed while processing data using the machine learning model, the constellation search component 125 may select the constellation set 120 that corresponds to the current iteration index (e.g., defined as a hyperparameter).

That is, in some aspects, the feature matching is being performed as part of an iterative refinement implementation. Specifically, in some aspects, the estimation (e.g., feature matching) algorithm may be used for multiple runs or iterations (rather than a single run or iteration) to refine the estimates iteratively (e.g., to achieve higher accuracy). For example, the feature matching may be performed as part of a neural network model or other machine learning model, where the matching is performed iteratively to progressively refine the matching and reduce error (at the cost of more iterations of computation), where the output of one iteration is used as the input to the next iteration.

In some aspects, rather than dynamically selecting the constellation set 120 based on the tensors 115, the constellation search component 125 may use a static or predefined constellation set 120 (e.g., indicated by a user). In some aspects, the constellation search component 125 may perform the feature match operation using multiple constellation sets 120. For example, the constellation search component 125 may perform the operation multiple times or iterations, each time using a different constellation set 120.

In some aspects, if the tensors 115 are of shape D×H×W (e.g., three-dimensional tensors with a height of H, a width of W, and a depth of D, and the correlation tensor 130 is of shape 1×H×W. That is, the constellation search component 125 may perform feature matching in the spatial dimensions. In some aspects, the constellation search component 125 may optionally use batch (e.g., parallel) processing to process the tensors 115, if supported. In such cases, the input tensor may be defined as having shape B×D×H×W and the correlation tensor 130 may be defined as D×1×H×W, where B is the batch size (e.g., the number of pairs of tensors that are processed in parallel).

In some aspects, the constellation search component 125 may, for each respective offset included in the selected constellation set 120, generate a respective shifted tensor by shifting the target tensor 115 by the respective offset. This results in ∥C∥ shifted tensors for a constellation set 120 having ∥C∥ elements or offsets. For example, if an offset is (−2,1), the constellation search component 125 may shift the target tensor 115 left by two and up by one (or right by two and down by one, depending on the particular implementation).

In some aspects, the shifting may be performed in-place by reusing input storage to support new indexing for the shifted tensor. That is, in some aspects, the constellation search component 125 performs a whole tensor shift, essentially moving coordinates of all features of the tensor by the same amount. In some aspects, for in-place tensor shifting, given that all elements move by same displacement, the constellation search component 125 may allocate a suitable constant-sized buffer and identify two regions to which the elements will be moved: a source region and the target region. To achieve the shift, the constellation search component 125 may first back up a suitably-sized portion of elements in the target region (so as to not lose them), and then start an element-by-element (or patch-by-patch) sequential content copying until the end of the tensor (into the addresses from which the portion were copied to the target region). Then, the constellation search component 125 can write back the backed-up portion of the elements (from the target region) to the suitable destination. Overall, therefore, the constellation search component 125 may perform the in-place tensor shifting without needing to allocate two full copies of complete tensor-sized space, and may instead use a relatively small buffer of space.

In some aspects, the constellation search component 125 performs the shifting with concomitant padding and/or deletion of elements to ensure that the shifted tensor has the same shape as the original target tensor 115. For example, in some aspects, the constellation search component 125 pads the target tensor 115 on all four spatial sides by a size of

$$p = floor ( max ( \frac{C [ i ]}{2} ) ) ,$$

where p is the number of elements added to each spatial side of the target tensor 115, C[i] is the i-th offset in constellation C, max(⋅) returns the largest value (e.g., the h or w offset divided by two, whichever is larger), and floor(⋅) is used to ensure an integer value is used to pad the tensor. In some aspects, this padding may include zero-padding (e.g., padding with elements having a value of zero) and/or edge replication padding (e.g., padding with the value of the elements that are originally at the edge of the tensor) on all four edges in H and W. In some aspects, the padding may similarly be performed in-place. As a result, the padded and shifted tensor may have a shape of D×(H+2p)×(W+2p). In some aspects, as discussed above, the constellation search component 125 may then delete one or more elements of the padded and shifted tensor (e.g., to return it to the original size, which matches the dimensionality of the reference tensor) while maintaining the appropriate shift.

In some aspects, the constellation search component 125 can then perform Hadamard multiplication (e.g., elementwise multiplication) between the reference tensor and the padded and each shifted target tensor. In some aspects, rather than performing the elementwise multiplication separately for each shifted target tensor (e.g., performing ∥C∥ such multiplications), the constellation search component 125 may first stack the shifted tensors (e.g., concatenating the shifted tensors along their depth channel), and then perform elementwise multiplication between the reference tensor and the stacked padded shifted target tensors. In some aspects, the output of the elementwise multiplication may be referred to as an “intermediate” tensor for conceptual clarity. As there may be ∥C∥ shifted target tensors, there may therefore be ∥C∥ intermediate tensors.

In some aspects, the constellation search component 125 may then, for each intermediate tensor, apply a flattening operation along the depth dimension to reduce the shape from D×H×W to 1×H×W. For example, the constellation search component 125 may use a reduce-to-mean operation, which returns the average (mean) value for the elements at each (h,w) index across the depth D. In some aspects, these may be referred to as flattened tensors.

In some aspects, the constellation search component 125 may then aggregate the flattened tensors along the depth dimension, such as by concatenating the flattened tensors along the depth. This aggregated tensor may be referred to as the correlation tensor 130. In some aspects, the correlation tensor 130 has shape ∥C∥×H×W (or B×∥C∥×H×W if batch processing is used). In some aspects, prior to or subsequent to aggregating the flattened tensors, the correlation tensor 130 may apply a weight to each flattened tensor based on the offset, from the constellation set 120, which was used to generate the flattened tensor. That is, each respective offset in the constellation set 120 may have an associated respective weight (e.g., manually defined as a hyperparameter and/or learned during training), and the respective weight may be multiplied by each element in the corresponding flattened tensor that was generated based on the respective offset. This allows the constellation search component 125 to weight the correlation tensor 130 on a per-offset basis.

In the illustrated example, the correlation tensor 130 is then accessed by the filter component 135. The filter component 135 can generally be used to perform a variety of operations to generate the output 140 (referred to in some aspects as feature matching output) of the machine learning model. For example, the filter component 135 may comprise or correspond to a regression filter that regresses the correlation tensor 130 to generate the feature matching results. Generally, the particular operations used by the filter component 135 may vary depending on the particular implementation. For example, in some aspects, the filter component 135 may use one or more convolution layer(s) (e.g., in a convolutional neural network (CNN)) to process the correlation tensor 130, or may comprise a recurrent neural network (RNN), a long short-term memory (LSTM) network, a gated recurrence unit (GRU) model, a multilayer perceptron (MLP), and the like.

In some aspects, as discussed below in more detail, the filter component 135 may select a different filter (also referred to as an artificial neural network filter in some aspects) based on which constellation set 120 was used to generate the correlation tensor 130. That is, each constellation set 120 may have a corresponding regression filter that is used to process the correlation tensor 130.

As discussed above, the particular contents and format of the output 140 may vary depending on the particular implementation. For example, as discussed above, the output 140 may include keypoint detection (e.g., indicating keypoints in the image(s) 105), landmark detection (e.g., indicating landmark(s) in the image(s) 105), two- and/or three-dimensional object localization and/or tracking (e.g., indicating the location and/or movement of one or more objects as depicted in the image(s) 105), two and/or three dimensional geometric correspondence (e.g., motion estimation and/or depth estimation for the image(s) 105), and the like.

Although the illustrated example depicts a single constellation feature matching operation being performed by the machine learning model, in some aspects, the model may include multiple iterations of feature matching, as discussed above.

As discussed above, by using constellation feature matching to generate the correlation tensors 130, the machine learning system can produce substantially improved results (e.g., output 140 that is more accurate than some conventional approaches to feature matching) with reduced computational expense (e.g., reduced latency, reduced memory usage, and/or reduced power consumption).

### Example Constellation Sets for Machine Learning Feature Matching

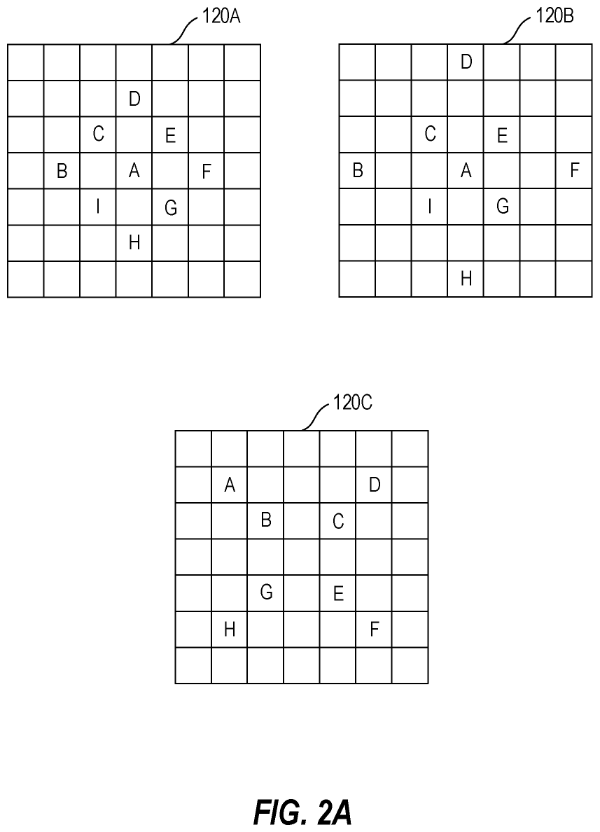

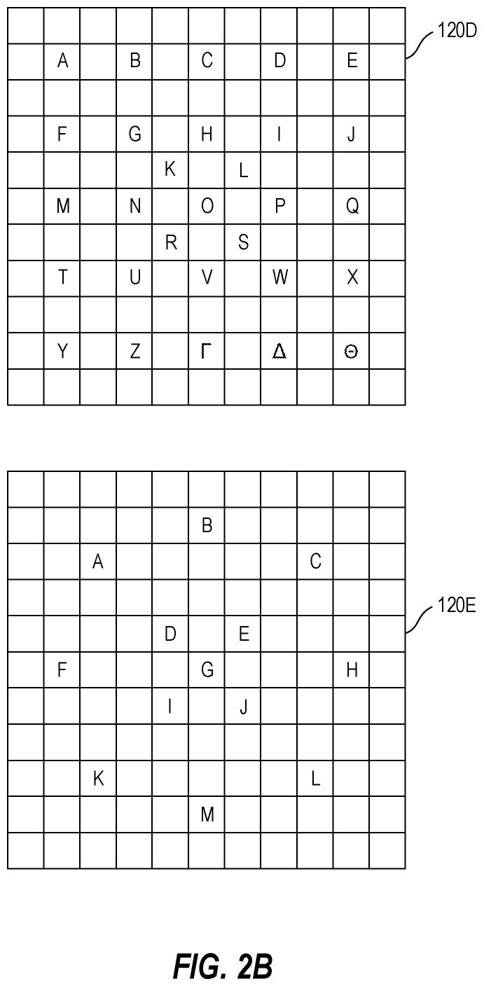

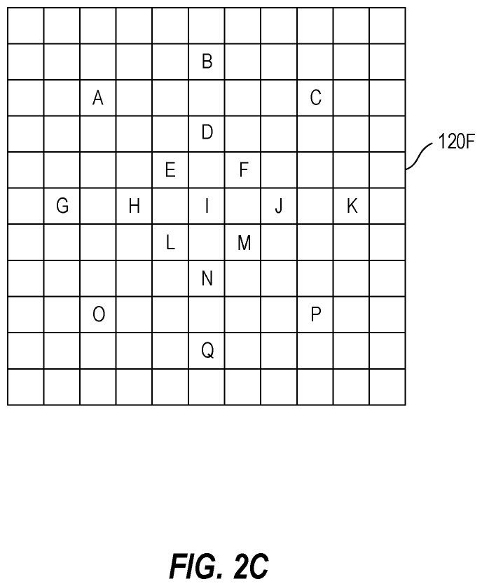

FIGS. 2A, 2B, and 2C depict example constellation sets 120A-F for machine learning feature matching, according to some aspects of the present disclosure.

In the illustrated examples, the offsets of each constellation set 120 are defined relative to the center point of the respective constellation set 120 for conceptual clarity. However, as discussed above, the machine learning system may generally use any element as the reference point or origin for a given constellation set 120. As discussed above, each constellation set 120 is generally defined as an unordered list of offsets relative to this origin. In some aspects, each offset may have an associated weight that can be used to weight the flattened tensors, as discussed above. Generally, the offset(s) and/or weight(s) of each constellation set 120 may be specified as a hyperparameter of the machine learning model (e.g., defined by a user) and/or may be learned during training of the machine learning model. In the illustrated examples, elements or offsets that are included in a constellation set 120 are indicated by a character, while elements or offsets that are not included in the constellation set 120 are blank.

Turning to FIG. 2A, the constellation set 120A includes nine offsets arranged in a sparse diamond pattern. Specifically, the constellation set 120A includes offset (0,0) (labeled with “A”), offset (−2,0) (labeled with “B”), offset (−1,−1) (labeled with “C”), offset (0,2) (labeled with “D”), offset (1,1) (labeled with “E”), offset (2,0) (labeled with “F”), offset (1,−1) (labeled with “G”), offset (0,−2) (labeled with “H”), and offset (−1,−1) (labeled with “I”). As discussed above, performing the constellation feature matching using the constellation set 120A generally comprises generating a shifted target tensor for each offset in the constellation (e.g., nine shifted tensors for the constellation set 120A), performing elementwise multiplication between the reference tensor and each shifted target tensor (resulting in nine intermediate tensors), flattening the intermediate tensors along the depth dimension, and concatenating the flattened tensors (to form a correlation tensor with a depth of nine).

As discussed above, the constellation feature matching can generally be performed in linear time with respect to the number of offsets in the constellation, regardless of how densely or sparsely the offsets are arranged. In some aspects, as discussed above, the receptive field of a constellation set 120 may affect how accurately the feature matching is performed with respect to long-range and short-range matching. As used herein, a constellation set's “receptive field” refers to the distance between the most extreme offsets in the constellation set. For example, the receptive field of the constellation set 120A may be defined as five, based on the relative distance between the offset labeled “B” and the offset labeled “F” (e.g., because the constellation set 120A covers five elements in the horizontal direction). In some aspects, the receptive field may be defined based on the larger distance (e.g., horizontal or vertical) if the constellation set 120A is not symmetrical. In some aspects, the receptive field may be defined based on the spacing in both directions (e.g., the constellation set 120A may have a receptive field of 5×5).

In some aspects, smaller receptive fields generally rely on performing more search iterations to converge or complete, as compared to larger receptive fields. However, larger receptive fields may result in reduced granularity, depending on the particular pattern used. Larger receptive fields may similarly result in somewhat increased latency (e.g., due to using more offsets).

In the illustrated example, the constellation set 120B has the same size as the constellation set 120A (e.g., the same number of offsets), but has increased receptive field. This may allow the constellation set 120B to cover a wider area and achieve higher long-range feature matching without increasing computational expense. Specifically, the constellation set 120B includes offset (0,0) (labeled with “A”), offset (−3,0) (labeled with “B”), offset (−1,−1) (labeled with “C”), offset (0,3) (labeled with “D”), offset (1,1) (labeled with “E”), offset (3,0) (labeled with “F”), offset (1,−1) (labeled with “G”), offset (0,−3) (labeled with “H”), and offset (−1,−1) (labeled with “I”). As discussed above, the receptive field of the constellation set 120B may be seven (or 7×7).

As illustrated, the constellation set 120C includes eight offsets, and has a receptive field of five (or 5×5). Specifically, the constellation set 120C includes offset (−2,2) (labeled with “A”), offset (−1,1) (labeled with “B”), offset (1,1) (labeled with “C”), offset (2,2) (labeled with “D”), offset (1,−1) (labeled with “E”), offset (2,−2) (labeled with “F”), offset (−1,−1) (labeled with “G”), and offset (−2,−2) (labeled with “H”).

Turning to FIG. 2B, two more example constellation sets 120 are illustrated. The constellation set 120D contains twenty-nine elements, and has a receptive field of nine (or 9×9). Specifically, the constellation set 120D includes offset (−4,4) (labeled with “A”), offset (−2,4) (labeled with “B”), offset (0,4) (labeled with “C”), offset (2,4) (labeled with “D”), offset (4,4) (labeled with “E”), offset (−4,2) (labeled with “F”), offset (−2,2) (labeled with “G”), offset (0,2) (labeled with “H”), offset (2,2) (labeled with “I”), offset (2,4) (labeled with “J), offset (−1,1) (labeled with “K”), offset (1,1) (labeled with “L”), offset (−4,0) (labeled with “M”), offset (−2,0) (labeled with “N”), offset (0,0) (labeled with “O”), offset (2,0) (labeled with “P”), offset (4,0) (labeled with “Q”), offset (−1,−1) (labeled with “R”), offset (1,−1) (labeled with “S”), offset (−4,−2) (labeled with “T”), offset (−2,−2,) (labeled with “U”), offset (0,−2) (labeled with “V”), offset (2,−2) (labeled with “W”), offset (4,−2) (labeled with “X”), offset (−4,−4) (labeled with “Y”), offset (−2,−4) (labeled with “Z”), offset (0,−4) (labeled with “T”), offset (2,−4) (labeled with “A”), and offset (4,−4) (labeled with “Θ”).

The constellation set 120E similarly has a receptive field of nine (or 9×9) but only contains thirteen elements or offsets. Specifically, the constellation set 120E includes offset (−3,3) (labeled with “A”), offset (0,4) (labeled with “B”), offset (3,3) (labeled with “C”), offset (−1,1) (labeled with “D”), offset (1,1) (labeled with “E”), offset (−4,0) (labeled with “F”), offset (0,0) (labeled with “G”), offset (4,0) (labeled with “H”), offset (−1,−1) (labeled with “I”), offset (1,−1) (labeled with “J”), offset (−3,−3) (labeled with “K”), offset (0,−4) (labeled with “M”), and offset (3,−3) (labeled with “L”).

Turning now to FIG. 2C, a constellation set 120F is depicted. The constellation set 120F has a receptive field of nine (or 9×9) band contains seventeen elements or offsets. Specifically, the constellation set 120F includes offset (−3,3) (labeled with “A”), offset (0,4) (labeled with “B”), offset (3,3) (labeled with “C”), offset (0,2) (labeled with “D”), offset (−1,1) (labeled with “E”), offset (1,1) (labeled with “F”), offset (−4,0) (labeled with “G”), offset (−2,0) (labeled with “H”), offset (0,0) (labeled with “I”), offset (2,0) (labeled with “J”), offset (4,0) (labeled with “K”), offset (−1,−1) (labeled with “L”), offset (1,−1) (labeled with “M”), offset (0,−2) (labeled with “N”), offset (−3,−2) (labeled with “O”), offset (3,−3) (labeled with “P”), and offset (0,−4) (labeled with “Q”).

In some aspects, constellation sets 120 that are relatively denser near the center of the constellation (e.g., the constellation sets 120B, 120D, 120E, and/or 120F) may exhibit improved accuracy for some datasets and models, as compared to constellation sets 120 that are sparser near the center and/or have uniform density, in some implementations. For example, such designs may enable accurate long-range feature matching (due to the wide receptive field) while maintain high short-range feature matching (due to the denser center section). These designs may therefore be useful for architectures that do not adaptively or dynamically switch between constellation sets 120 (e.g., as a general design).

The illustrated constellation sets 120A-F of FIGS. 2A-2C are included as examples for conceptual clarity, and are not limiting on the aspects disclosed herein. A wide variety of other constellation sets, each having any number of offsets arranged in any arrangement or pattern (e.g., vertically symmetric, horizontally symmetric, asymmetric in one or both dimensions, and the like). Indeed, some tasks and/or datasets may substantially benefit from asymmetric constellation sets, which may be learned during training.

### Example Architecture for Adaptive Constellation Feature Matching for Machine Learning

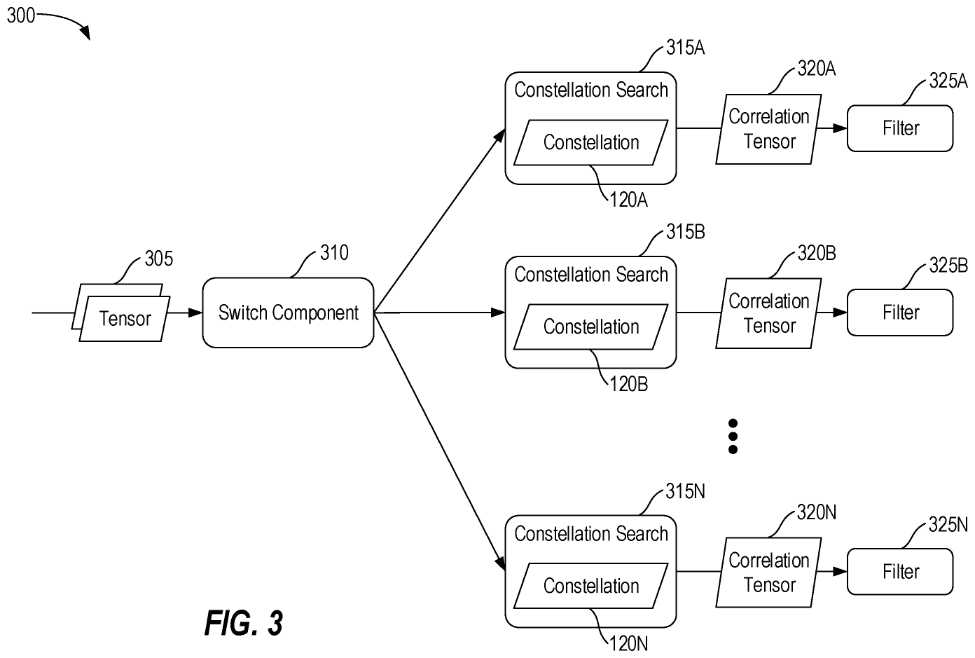

FIG. 3 depicts an architecture 300 for adaptive constellation feature matching for machine learning, according to some aspects of the present disclosure. In some aspects, the architecture 300 is used by a machine learning system, such as the machine learning system discussed above with reference to FIG. 1. For example, the constellation searches 315A-N may correspond to or be implemented by the constellation search component 125 of FIG. 1, and/or the filters 325A-N may correspond to or be implemented by the filter component 135 of FIG. 1.

In the illustrated example, a set of input tensors 305 are accessed by a switch component 310. In some aspects, the tensors 305 (also referred to as feature maps) are generated based on image(s) used as input to a machine learning model. For example, the tensors 305 may correspond to the tensors 115 of FIG. 1. In some aspects, as discussed above, the tensors 305 may include at least a pair of tensors 305, which may be referred to as a reference tensor and a target tensor for conceptual clarity. The architecture 300 may be used to provide dynamic or adaptive constellation feature matching between the tensors 305.

In the illustrated example, the switch component 310 selects one or more constellation searches 315A-N to process the tensor(s) 305, where each constellation search 315A-N uses a corresponding constellation set 120A-N to perform the constellation feature match. For example, the switch component 310 may be a component of a machine learning model that is used to perform various tasks that involve feature matching (e.g., computer vision tasks such as object tracking).

In some aspects, as discussed above, the switch component 310 may select the constellation search 315A-N based at least in part on one or more of the tensors 305. For example, the switch component 310 may evaluate the target tensor, the reference tensor, or both the target tensor and the reference tensor. In some aspects, the switch component 310 may determine the coherence between the target and reference tensors, and select the constellation search 315 based on the coherence.

For example, in some aspects, the switch component 310 may determine whether the coherency between the tensors satisfies one or more coherency criteria, such as whether the coherency meets or exceeds one or more defined threshold values (e.g., whether the tensors are highly correlated or coherent). As one example, the switch component 310 may use multiple thresholds, such as to select a first constellation search 315 (e.g., with a constellation set 120 having a high receptive field) for tensors having a coherency below a first threshold, a second constellation search 315 (e.g., with a constellation set 120 having a relatively smaller receptive field) for tensors having a coherency above the first threshold but below a second, and a third constellation search 315 (e.g., having a constellation set 120 with an even smaller receptive field) for tensors having a coherency above the second threshold.

In some aspects, in addition to or instead of evaluating the tensor coherence with defined thresholds or other criteria, the switch component 310 may process the tensor(s) 305 and/or coherence using one or more machine learning models. For example, as discussed above, a small classifier model (e.g., a small convolutional neural network) may be trained to select a constellation set and/or suggested receptive field based on the tensor(s) 305 and/or coherence.

In some aspects, in addition to or instead of evaluating the tensor(s) and/or coherence values to select the constellation search 315, the switch component 310 may evaluate other features such as the current iteration of the machine learning model (e.g., how many iterations of feature matching have already been performed).

In the illustrated example, each constellation search 315 is associated with a corresponding constellation set 120 and a corresponding filter 325. In this way, selecting a given constellation search 315 may be equivalent to selecting the corresponding constellation set 120 and filter 325. Specifically, in the illustrated example, the constellation search 315A uses the constellation set 120A to generate a correlation tensor 320A, which is then processed using a filter 325A to generate output of the model. Similarly, the constellation search 315B uses the constellation set 120B to generate a correlation tensor 320B. The correlation tensor 320B is then processed using the filter 325B to generate model output. Further, the constellation search 315N uses the constellation set 120N to generate the correlation tensor 320N, and the correlation tensor 320N is processed using the filter 325N to generate the model output.

Although three constellation searches 315, constellation sets 120, and filters 325 are depicted for conceptual clarity, in some aspects, any number of constellations (with corresponding filters) may be used. Further, although the illustrated example depicts each constellation search 315 using a corresponding filter 325, in some aspects, some or all of the correlation tensors 320 may be processed by a single filter 325 (regardless of which constellation set 120 was used to generate the correlation tensor 320).

In some aspects, as discussed above, each constellation search 315 corresponds to performing a constellation feature matching operation on the input tensors 305 using the corresponding constellation set 120 to generate a correlation tensor 320 indicating the feature matching results. The filters 325 generally correspond to processing the correlation tensors 320 using one or more further operations (e.g., regressions, convolutions, and the like) to generate the model output, such as depth estimations, object tracking, landmark detection, and the like.

Advantageously, by using the adaptive or dynamic architecture 300, the machine learning system may generate improved output. That is, by dynamically selecting which constellation set(s) 120 to use for a given set of input(s), the resulting feature matching may be substantially improved, resulting in improved predictions for the machine learning model.

### Example Method for Constellation Feature Matching for Machine Learning Models

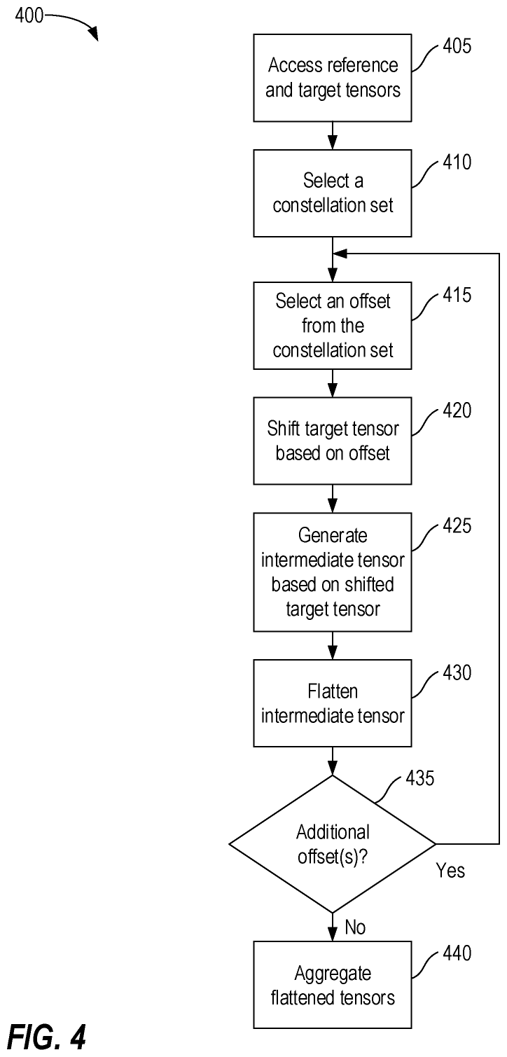

FIG. 4 is a flow diagram depicting an example method 400 for constellation feature matching for machine learning models, according to some aspects of the present disclosure. In some aspects, the method 400 may be performed by a machine learning system, such as the machine learning system discussed above with reference to FIGS. 1, 2A-2C, and/or 3.

At block 405, the machine learning system accesses a reference tensor and a target tensor (e.g., the tensors 115 of FIG. 1 and/or the tensors 305 of FIG. 3). In some aspects, as discussed above, the reference and target tensors correspond to feature maps generated based on a pair of input images (e.g., the images 105 of FIG. 1). For example, the sequential frames from a video may be processed to extract features from the frames to generate the tensors as part of processing the images using a machine learning model (e.g., a computer vision model), such as an artificial neural network. In some aspects, the machine learning system may evaluate reference and target tensors repeatedly or continuously (e.g., in real-time, as images are captured).

At block 410, the machine learning system select a constellation set to use to perform constellation feature matching for the accessed reference and target tensors. In some aspects, as discussed above, the machine learning system uses a single constellation set for all tensors (e.g., a constellation specified by a user, or a constellation set that was used when the model was trained). In some aspects, the machine learning system may dynamically select which constellation set, from a plurality of constellation sets, to use for a given set of tensors. For example, in some aspects, the machine learning system may evaluate the reference tensor and/or the target tensor to determine which constellation set to use.

In some aspects, as discussed above, the machine learning system may determine a coherence or disparity between the reference and target tensors (or between the original images themselves). In some aspects, the machine learning system may evaluate the coherency against one or more criteria (e.g., thresholds) to determine which constellation set to use. As another example, in some aspects, the machine learning system may process the coherency information and/or the tensors using a machine learning model (e.g., a small neural network) to predict which constellation set should be used.

In some aspects, in addition to or instead of evaluating the tensor(s) themselves, the machine learning system may evaluate other factors or criteria to select the constellation set. For example, as discussed above, the machine learning system may select the tensor based on the progress of the data passing through the model (e.g., based on which iteration, of a sequence of iterations, is currently being performed).

At block 415, the machine learning system selects an offset from the constellation set. As discussed above, each constellation set is generally defined as an unordered set of offsets, specified relative to some arbitrary origin point (e.g., the center of the constellation). The machine learning system can generally select the offset using any suitable technique or criteria, including randomly or pseudo-randomly, as each offset will be selected and processed during the method 400.

At block 420, the machine learning system shifts the target tensor based on the selected offset. That is, the machine learning system shifts the target tensor by the amount(s) and direction(s) indicated by the selected offset. In some aspects, as discussed above, this shifting may be performed in-place in memory (e.g., by altering the addressing algorithm without actually moving the data in memory). In some aspects, the machine learning system may further pad the target tensor and/or delete elements from the target tensor to maintain the original shape, as discussed above.

At block 425, the machine learning system generates an intermediate tensor based on the shifted target tensor. For example, as discussed above, the machine learning system may perform an elementwise multiplication between the reference tensor and the shifted target tensor.

At block 430, the machine learning system flattens the intermediate tensor along the depth dimension. For example, as discussed above, the machine learning system may use mean pooling to reduce the depth to one (while maintaining the spatial size of the tensor).

At block 435, the machine learning system determines whether there is at least one additional offset remaining in the selected constellation set. If so, the method 400 returns to block 415. If not, the method 400 continues to block 440. Although the illustrated example depicts an iterative or sequential process (e.g., selecting and evaluating each offset in turn), in some aspects, the machine learning system may process some or all of the offsets in parallel, as discussed above. For example, the machine learning system may aggregate (e.g., concatenate) the shifted target tensors for multiple offsets, and perform elementwise multiplication between the reference tensor and the aggregated tensor stack.

At block 440, the machine learning system aggregates the flattened tensors. For example, the machine learning system may stack or concatenate the flattened tensors along the depth dimension, as discussed above. As discussed above, aggregating the flattened tensors yields a correlation tensor for the target and reference tensors. Generally, the correlation tensor may have the same spatial dimensionality as the target and reference tensors, and may have a depth equal to the number of offsets included in the selected constellation set. In some aspects, as discussed above, the flattened tensors may be weighted based on weight(s) associated with the offset(s). For example, each offset may have a corresponding weight (e.g., learned during training, or specified as a hyperparameter), and the machine learning system may weight each flattened tensor based on the weight associated with the offset that was used to generate the flattened tensor (e.g., by multiplying each element of the flattened tensor by the corresponding weight of the offset).

In some aspects, as discussed above, the correlation tensor may then be processed using one or more downstream operations (e.g., regression filters) to generate the model output. In some aspects, the machine learning system may select the filter based at least in part on which constellation set was selected and used to generate the correlation tensor, as discussed above. For example, there may be a one-to-one mapping between constellation sets and corresponding filters. This may allow each filter to specialize, during training, to the particular correlation tensors generated using each particular constellation set. Such an approach may improve model accuracy substantially, in some cases.

As discussed above, the model output may take a variety of forms, and can generally include any output that depends, at least in part, on the feature matching performed using the constellation set. For example, the output may include object detection or tracking, motion tracking, depth estimation, and the like. Generally, this output may enable the machine learning system (or another system) to take one or more actions based on the predictions. For example, an autonomous vehicle may capture image(s) while moving through physical space, and provide the image(s) to the machine learning system to perform various tasks such as depth estimation and motion tracking. The autonomous vehicle may then use the generated model outputs, provided by the machine learning system, to perform tasks such as steering, controlling acceleration, route planning, and the like.

Advantageously, using constellation feature matching, the machine learning system is able to provide more accurate output predictions using substantially fewer computational resources (e.g., less compute, less memory, and the like) while also consuming less power and introducing less latency, as compared to some conventional approaches. Further, the constellation feature matching may enable substantially improved prediction accuracy for some implementations.

### Example Method for Feature Matching

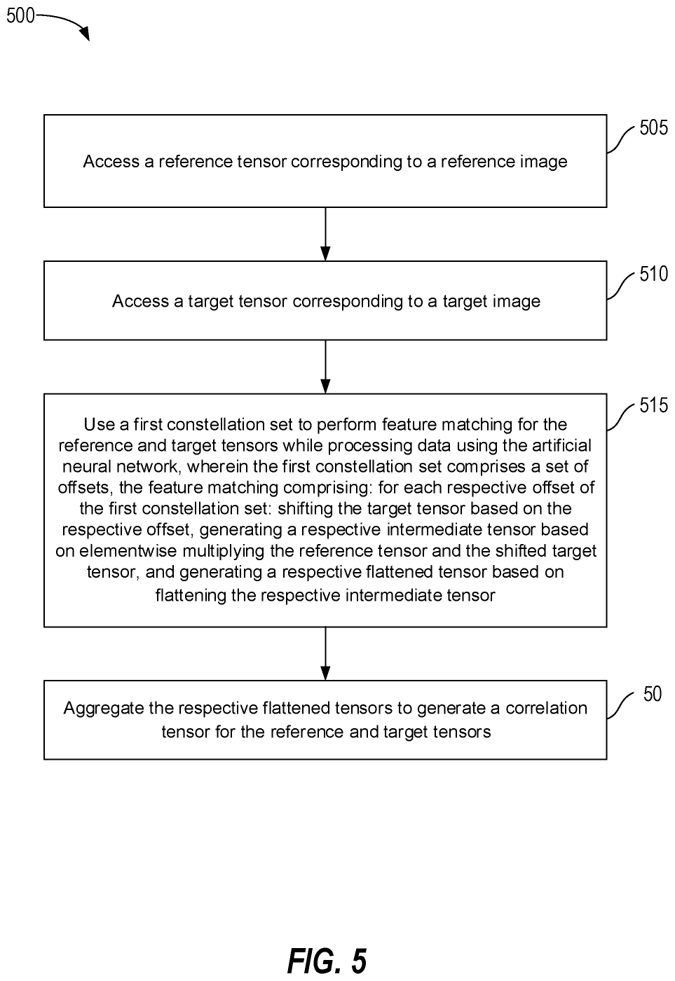

FIG. 5 is a flow diagram depicting an example method 500 for feature matching, according to some aspects of the present disclosure. In some aspects, the method 500 may be performed by a machine learning system, such as the machine learning system discussed above with reference to FIGS. 1, 2A-2C, 3, and/or 4.

At block 505, a reference tensor corresponding to a reference image is accessed.

At block 510, a target tensor corresponding to a target image is accessed.

At block 515, a first constellation set is used to perform feature matching for the reference and target tensors while processing data using the artificial neural network, wherein the first constellation set comprises a set of offsets, the feature matching comprising, for each respective offset of the first constellation set: shifting the target tensor based on the respective offset, generating a respective intermediate tensor based on elementwise multiplying the reference tensor and the shifted target tensor, and generating a respective flattened tensor based on flattening the respective intermediate tensor.

At block 520, the respective flattened tensors are aggregated to generate a correlation tensor for the reference and target tensors.

In some aspects, the method 500 further includes generating a feature matching output for the target image and the reference image based on processing the correlation tensor using an artificial neural network filter of the artificial neural network.

In some aspects, the method 500 further includes selecting the artificial neural network filter from a plurality of artificial neural network filters based on the first constellation set.

In some aspects, the method 500 further includes selecting the first constellation set from a plurality of constellation sets based on at least one of the reference tensor or the target tensor.

In some aspects, selecting the first constellation set comprises: determining a coherency based at least in part on the reference tensor and the target tensor, and selecting the first constellation set based on the coherency.

In some aspects, the first constellation set of the plurality of constellation sets corresponds to a first receptive field, a second constellation set of the plurality of constellation sets corresponds to a second receptive field larger than the first receptive field, and the first constellation set is selected to perform the feature matching, over the second constellation set, in response to determining that the coherency satisfies one or more coherency criteria.

In some aspects, the coherency criteria comprise one or more threshold values, and wherein determining that the coherency satisfies the one or more coherency criteria comprises determining that the coherency meets or exceeds the one or more threshold values.

In some aspects, selecting the first constellation set comprises processing the at least one of the reference tensor or the target tensor using a preliminary portion of the artificial neural network.

In some aspects, the set of offsets of the first constellation set was learned during training of the artificial neural network.

In some aspects, the set of offsets of the first constellation set is specified as a hyperparameter of the artificial neural network.

In some aspects, each respective flattened tensor is respectively weighted prior to the aggregating of the respective flattened tensors.

In some aspects, the flattening comprises averaging values of the respective intermediate tensor across a depth dimension.

In some aspects, the method 500 further includes taking one or more actions based on the correlation tensor.

In some aspects, the taking one or more actions comprises performing, based on the correlation tensor, at least one of: (i) tracking of a visual object in a video, (ii) motion estimation, or (iii) depth estimation.

### Example Processing System for Machine Learning

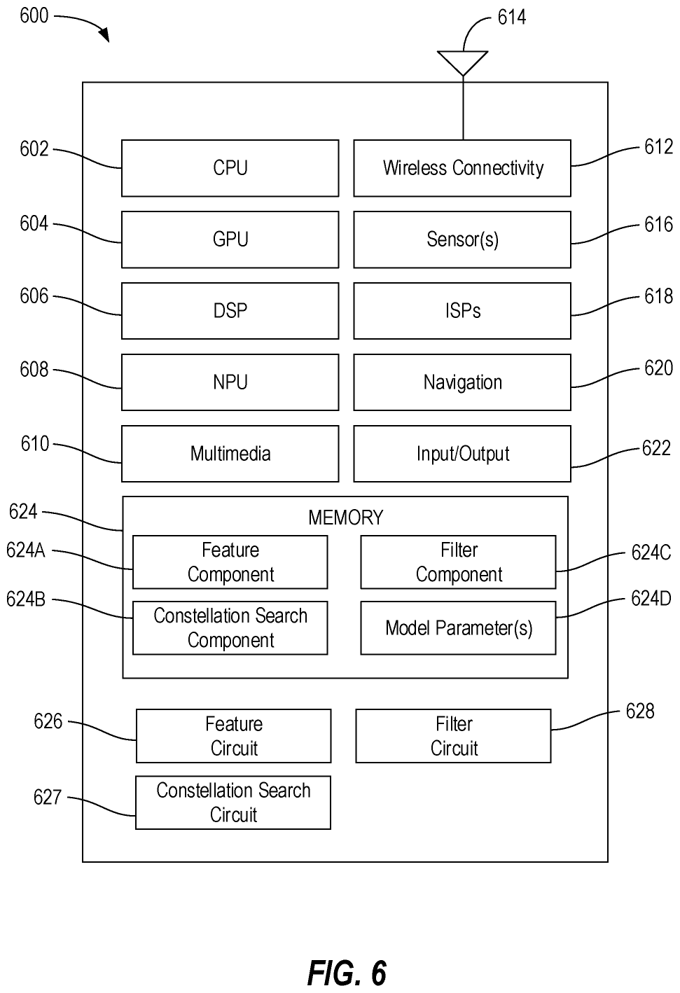

FIG. 6 depicts an example processing system 600 configured to perform various aspects of the present disclosure, including, for example, the techniques and methods described with respect to FIGS. 1, 2A-2C, 3, 4, and/or 5. In some aspects, the processing system 600 may correspond to a machine learning system. For example, the processing system 600 may correspond to the machine learning system discussed above with reference to FIGS. 1, 2A-2C, 3, 4, and/or 5. Although depicted as a single system for conceptual clarity, in some aspects, as discussed above, the operations described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of a memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as the NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a feature component 624A, a constellation search component 624B, and a filter component 624C. Although not depicted in the illustrated example, the memory 624 may also include other components, such as an inferencing or generation component to manage the generation of output predictions using trained machine learning models, a training component used to train or update the machine learning model(s) and/or constellation sets, and the like. Though depicted as discrete components for conceptual clarity in FIG. 6, the illustrated components (and others not depicted) may be collectively or individually implemented in various aspects.

As illustrated, the memory 624 also includes a set of model parameters 624D (e.g., parameters of one or more machine learning models or components thereof). For example, the model parameters 624D may include parameters for an artificial neural network, such as for feature extraction, regression, convolution, classifiers for selecting constellation sets, and the like. In some aspects, as discussed above, the model parameters 624D may also include constellation sets, such as offsets and/or offset weights (which may be learned during training, or may be specified as hyperparameters). Although not depicted in the illustrated example, the memory 624 may also include other data such as training data (e.g., images and/or tensors with corresponding computer vision output (e.g., object tracking labels) and/or constellation labels (e.g., indicating which constellation set to use).

The processing system 600 further comprises a feature circuit 626, a constellation search circuit 627, and a filter circuit 628. The depicted circuits, and others not depicted (such as an inferencing circuit), may be configured to perform various aspects of the techniques described herein.

The feature component 624A and/or the feature circuit 626 (which may correspond to the feature component 110 of FIG. 1) may be used to perform feature extraction on input data in order to facilitate constellation searching, as discussed above. For example, the feature component 624A and/or the feature circuit 626 may use various trained components (e.g., encoder models) to extract features from images in order to generate corresponding feature maps (e.g., target and reference tensors) for the input images.

The constellation search component 624B and/or the constellation search circuit 627 (which may correspond to the constellation search component 125 of FIG. 1, the switch component 310 of FIG. 3, and/or the constellation searches 315 of FIG. 3) may be used to perform constellation feature matching using constellation sets (e.g., the constellation sets 120 of FIGS. 1, 2A-2C, and/or 3), as discussed above. For example, the constellation search component 624B and/or the constellation search circuit 627 may select a constellation set (e.g., from the model parameters 624D) and use the selected constellation set to perform feature matching for a pair (or set) of tensors (e.g., feature maps) to generate correlation tensors for the set.

The filter component 624C and/or the filter circuit 628 (which may correspond to the filter component 135 of FIG. 1 and/or the filters 325 of FIG. 3) may be used to evaluate correlation tensors to generate model output, as discussed above. For example, the filter component 624C and/or the filter circuit 628 may use trained components (e.g., regression filters, CNNs, LSTMs, GRUs, RNNs, MLPs, and the like) to generate computer vision model output (e.g., depth estimations, motion tracking, and the like) based on the correlation tensors.

Though depicted as separate components and circuits for clarity in FIG. 6, the feature circuit 626, the constellation search circuit 627, and the filter circuit 628 may collectively or individually be implemented in other processing devices of the processing system 600, such as within the CPU 602, the GPU 604, the DSP 606, the NPU 608, and the like.

Generally, the processing system 600 and/or components thereof may be configured to perform the methods described herein.

Notably, in other aspects, aspects of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 maybe distributed between multiple devices.

### EXAMPLE CLAUSES

Implementation examples are described in the following numbered clauses:

Clause 1: A method, comprising: accessing a reference tensor corresponding to a reference image; accessing a target tensor corresponding to a target image; and using a first constellation set to perform feature matching for the reference and target tensors while processing data using the artificial neural network, wherein the first constellation set comprises a set of offsets, the feature matching comprising: for each respective offset of the first constellation set: shifting the target tensor based on the respective offset; generating a respective intermediate tensor based on elementwise multiplying the reference tensor and the shifted target tensor; and generating a respective flattened tensor based on flattening the respective intermediate tensor; and aggregating the respective flattened tensors to generate a correlation tensor for the reference and target tensors.

Clause 2: A method according to Clause 1, further comprising generating a feature matching output for the target image and the reference image based on processing the correlation tensor using an artificial neural network filter of the artificial neural network.

Clause 3: A method according to Clause 2, further comprising selecting the artificial neural network filter from a plurality of artificial neural network filters based on the first constellation set.

Clause 4: A method according to any of Clauses 1-3, further comprising selecting the first constellation set from a plurality of constellation sets based on at least one of the reference tensor or the target tensor.

Clause 5: A method according to Clause 4, wherein selecting the first constellation set comprises: determining a coherency based at least in part on the reference tensor and the target tensor; and selecting the first constellation set based on the coherency.

Clause 6: A method according to Clause 5, wherein: the first constellation set of the plurality of constellation sets corresponds to a first receptive field, a second constellation set of the plurality of constellation sets corresponds to a second receptive field larger than the first receptive field, and the first constellation set is selected to perform the feature matching, over the second constellation set, in response to determining that the coherency satisfies one or more coherency criteria.

Clause 7: A method according to Clause 6, wherein the coherency criteria comprise one or more threshold values, and wherein determining that the coherency satisfies the one or more coherency criteria comprises determining that the coherency meets or exceeds the one or more threshold values.

Clause 8: A method according to any of Clauses 4-7, wherein selecting the first constellation set comprises processing the at least one of the reference tensor or the target tensor using a preliminary portion of the artificial neural network.

Clause 9: A method according to any of Clauses 1-8, wherein the set of offsets of the first constellation set was learned during training of the artificial neural network.

Clause 10: A method according to any of Clauses 1-9, wherein the set of offsets of the first constellation set is specified as a hyperparameter of the artificial neural network.

Clause 11: A method according to any of Clauses 1-10, wherein each respective flattened tensor is respectively weighted prior to the aggregating of the respective flattened tensors.

Clause 12: A method according to any of Clauses 1-11, where the flattening comprises averaging values of the respective intermediate tensor across a depth dimension.

Clause 13: A method according to any of Clauses 1-12, further comprising taking one or more actions based on the correlation tensor.

Clause 14: A method according to Clause 13, wherein the taking one or more actions comprises performing, based on the correlation tensor, at least one of: (i) tracking of a visual object in a video, (ii) motion estimation, or (iii) depth estimation.

Clause 15: A processing system comprising: a memory comprising computer-executable instructions; and one or more processors configured to execute the computer-executable instructions and cause the processing system to perform a method in accordance with any of Clauses 1-14.

Clause 16: A processing system comprising means for performing a method in accordance with any of Clauses 1-14.

Clause 17: A non-transitory computer-readable medium comprising computer-executable instructions that, when executed by one or more processors of a processing system, cause the processing system to perform a method in accordance with any of Clauses 1-14.

Clause 18: A computer program product embodied on a computer-readable storage medium comprising code for performing a method in accordance with any of Clauses 1-14.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors configured to execute the processor-executable instructions and cause the processing system to:
access a reference tensor corresponding to a reference image;
access a target tensor corresponding to a target image; and
use a first constellation set to perform feature matching for the reference and target tensors while processing data using an artificial neural network, wherein the first constellation set comprises a set of offsets, and wherein, to perform the feature matching, the one or more processors are configured to execute the processor-executable instructions and cause the processing system to:
for each respective offset of the first constellation set:
shift the target tensor based on the respective offset;
generate a respective intermediate tensor based on elementwise multiplying the reference tensor and the shifted target tensor; and
generate a respective flattened tensor based on flattening the respective intermediate tensor; and
aggregate the respective flattened tensors to generate a correlation tensor for the reference and target tensors.

2. The processing system of claim 1, wherein the one or more processors are configured to further execute the processor-executable instructions and cause the processing system to generate a feature matching output for the target image and the reference image based on processing the correlation tensor using an artificial neural network filter of the artificial neural network.

3. The processing system of claim 2, wherein the one or more processors are configured to further execute the processor-executable instructions and cause the processing system to select the artificial neural network filter from a plurality of artificial neural network filters based on the first constellation set.

4. The processing system of claim 1, wherein the one or more processors are configured to further execute the processor-executable instructions and cause the processing system to select the first constellation set from a plurality of constellation sets based on at least one of the reference tensor or the target tensor.

5. The processing system of claim 4, wherein, to select the first constellation set, the one or more processors are configured to execute the processor-executable instructions and cause the processing system to:
determine a coherency based at least in part on the reference tensor and the target tensor; and
select the first constellation set based on the coherency.

6. The processing system of claim 5, wherein:
the first constellation set of the plurality of constellation sets corresponds to a first receptive field,
a second constellation set of the plurality of constellation sets corresponds to a second receptive field larger than the first receptive field, and
the one or more processors are configured to execute the processor-executable instructions and cause the processing system to select the first constellation set to perform the feature matching, over the second constellation set, in response to determining that the coherency satisfies one or more coherency criteria.

7. The processing system of claim 6, wherein the coherency criteria comprise one or more threshold values, and wherein, to determine that the coherency satisfies the one or more coherency criteria, the one or more processors are configured to execute the processor-executable instructions and cause the processing system to determine that the coherency meets or exceeds the one or more threshold values.

8. The processing system of claim 4, wherein, to select the first constellation set, the one or more processors are configured to execute the processor-executable instructions and cause the processing system to process the at least one of the reference tensor or the target tensor using a preliminary portion of the artificial neural network.

9. The processing system of claim 1, wherein the set of offsets of the first constellation set was learned during training of the artificial neural network.

10. The processing system of claim 1, wherein the set of offsets of the first constellation set is specified as a hyperparameter of the artificial neural network.

11. The processing system of claim 1, wherein each respective flattened tensor is configured to be respectively weighted prior to the aggregation of the respective flattened tensors.

12. The processing system of claim 1, wherein, to flatten the respective intermediate tensor, the one or more processors are configured to execute the processor-executable instructions and cause the processing system to average values of the respective intermediate tensor across a depth dimension.

13. The processing system of claim 1, wherein the one or more processors are configured to further execute the processor-executable instructions and cause the processing system to take one or more actions based on the correlation tensor.

14. The processing system of claim 13, wherein, to take the one or more actions, the one or more processors are configured to execute the processor-executable instructions and cause the processing system to perform, based on the correlation tensor, at least one of: (i) tracking of a visual object in a video, (ii) motion estimation, or (iii) depth estimation.

15. A processor-implemented method for an artificial neural network, comprising:
accessing a reference tensor corresponding to a reference image;
accessing a target tensor corresponding to a target image; and
using a first constellation set to perform feature matching for the reference and target tensors while processing data using the artificial neural network, wherein the first constellation set comprises a set of offsets, the feature matching comprising:
for each respective offset of the first constellation set:
shifting the target tensor based on the respective offset;
generating a respective intermediate tensor based on element wise multiplying the reference tensor and the shifted target tensor; and
generating a respective flattened tensor based on flattening the respective intermediate tensor; and
aggregating the respective flattened tensors to generate a correlation tensor for the reference and target tensors.

16. The method of claim 15, further comprising generating a feature matching output for the target image and the reference image based on processing the correlation tensor using an artificial neural network filter of the artificial neural network.

17. The method of claim 16, further comprising selecting the artificial neural network filter from a plurality of artificial neural network filters based on the first constellation set.

18. The method of claim 15, further comprising selecting the first constellation set from a plurality of constellation sets based on at least one of the reference tensor or the target tensor.

19. The method of claim 18, wherein selecting the first constellation set comprises:
determining a coherency based at least in part on the reference tensor and the target tensor; and
selecting the first constellation set based on the coherency.

20. The method of claim 15, further comprising performing, based on the correlation tensor, at least one of: (i) tracking of a visual object in a video, (ii) motion estimation, or (iii) depth estimation.
